(19) United States
(12) Patent Application Publication
(10) Pub. No.: US 2007/0084118 A1
(43) Pub. Date: Apr. 19, 2007

(54) Reformer and method for reacting fuel and oxidant to reformate

(75) Inventors: Stefan Kaeding, Zerrenthin (DE); Norbert Guenther, Ribnitz/Damgarten (DE)

Correspondence Address: ROBERTS, MLOTKOWSKI & HOBBES, P. O. BOX 10064, MCLEAN, VA, 22102-8064, US

(73) Assignee: Webasto AG, Stockdorf (DE)

(21) Appl. No.: 10/596,616

(22) PCT Filed: Dec. 16, 2004
(86) PCT No.: PCT/DE04/02758

§ 371 Date: Jun. 19, 2006

(30) Foreign Application Priority Data
Dec. 17, 2003 (DE) 103 59 205.9

(51) Int. Cl. C01B 3/24; C10J 3/46

(52) U.S. Cl. 48/197 R; 48/127.9

(57) ABSTRACT

A reformer for reacting fuel (12) and oxidant (16, 18, 20) into reformate (22). The reformer has an oxidizing zone (24), a reforming zone (26) and an injection and mixture forming zone between the oxidizing zone (24) and the reforming zone (26). A mixture of fuel (12) and oxidant (16, 18, 20) is delivered to the oxidizing zone (24) and is delivered at least in part to the reforming zone (26) following at least partial oxidation of the fuel (12). Fuel (14) and heat (28) can be supplied to the reforming zone (26) in a method for reacting fuel (12) and oxidant (16, 18, 20) into reformate.

The invention relates to a reformer for converting fuel and oxidant into reformate, comprising an oxidation zone and a reforming zone, wherein a mixture of fuel and oxidant may be supplied to the oxidation zone, and the mixture may be supplied at least partially to the reforming zone upon an at least partial oxidation of the fuel.

The invention relates further to a method for converting fuel and oxidant into reformate in a reformer having an oxidation zone and a reforming zone, wherein a mixture of fuel and oxidant is supplied to the oxidation zone, the mixture being supplied at least partially to the reforming zone upon an at least partial oxidation of the fuel.

Generic reformers and generic methods provide numerous fields of application. In particular, they serve for supplying a fuel cell with a hydrogen-rich gas mixture, from which electric energy may be generated on the basis of electrochemical processes. Such fuel cells are employed for example in the automotive field as auxiliary power sources, so called APUs (“auxiliary power unit”).

The reforming process for converting fuel and oxidant into reformate may proceed according to various concepts. For example, the catalytic reforming is known, in which part of the fuel is oxidized in an exothermic reaction. This catalytic reforming has the drawback of a high heat generation which may irreversibly harm the system components, in particular the catalytic converter.

Another possibility for generating reformate from hydrocarbons is the “steam-reforming”. In this process, hydrocarbons are converted within an endothermic reaction into hydrogen by the aid of water vapor.

A combination of these both concepts, that is, the reforming on the basis of an exothermic reaction and the production of hydrogen by means of an endothermic reaction in which the energy for steam-reforming is extracted from the combustion of hydrocarbons, is called an autothermic reforming. Herein, the additional drawbacks arise that a possibility for supplying water has to be provided. High temperature gradients between the oxidation zone and the reforming zone constitute further problems in the temperature management of the entire system.

An example for a reformer having an oxidation unit which is separated from a reforming unit is given in DE 199 43 248 A1.

The invention is based on the object to provide a reformer and a method for converting fuel and oxidant into reformate, in which the mentioned problems are overcome at least partially and in which, in particular, problems due to high temperatures and large temperature gradients do not occur, respectively.

This object is solved with the features of the independent claims.

Advantageous embodiments of the invention are defined in the dependent claims.

The invention is established beyond the generic reformer in that fuel may additionally be supplied to the reforming zone, and in that heat may be supplied to the reforming zone. The additionally supplied fuel thus forms together with the exhaust gas from the oxidation zone the starting gas mixture for the reforming process. Due to the mixing of the fuel with the exhaust gas, a small λ-value is provided (for example λ=0.4), and an endothermic reforming reaction can take place by supplying heat.

In this context it is especially beneficial that heat from the exothermic oxidation within the oxidation zone may be supplied to the reforming zone. The heat energy resulting from the oxidation zone is thus converted in the course of the reforming reaction such that the net heat generation of the entire process does not lead to problems in the temperature management of the reformer.

Advantageously it is provided that the reforming zone comprises an oxidation supply through which oxidant may be additionally supplied. In this manner a further parameter for influencing the reforming is provided, in order to optimize it.

The invention is in a very beneficial manner further developed in that the additional fuel may be supplied to an injection and mixture forming zone and in that the additional fuel can flow from the injection and mixture forming zone into the reforming zone. This injection and mixture forming zone is thus arranged upstream of the reforming zone such that the reforming zone is provided with a well mixed starting gas for the reforming reaction.

In this context it is especially beneficial that the additional fuel is at least partially evaporated by the thermal energy of the gas mixture exiting the oxidation zone. Thus the reaction heat from the oxidation may be utilized in a beneficial manner also for the evaporation process of the fuel.

Further, it may be beneficial that the gas mixture generated in the oxidation zone may be partially supplied to the reforming zone, bypassing the injection and mixture forming zone. Thereby, a further possibility for influencing the reforming process is provided such that a further improvement of the reformate exiting the reformer can be achieved with regards to its usage.

The invention is established beyond the generic method in that additional fuel is supplied to the reforming zone, and in that heat is supplied to the reforming zone. In this manner the advantages and special characteristics of the reformer according to the present invention are achieved also in the course of a method. This also applies for the following especially preferred embodiments of the method according to the present invention.

This method is beneficially further developed in that heat from the exothermic oxidation within the oxidation zone is supplied to the reforming zone.

Further, it may be beneficial that the reforming zone comprises an oxidant supply through which additional oxidant is supplied.

Within the scope of the method it is preferred that the additional fuel is supplied to an injection and mixture forming zone and that the additional fuel flows from the injection and mixture forming zone into the reforming zone.

In relation to the method it is beneficially envisaged that the additional fuel is evaporated at least partially by the thermal energy of the gas mixture exiting the oxidation zone.

Further, it can be provided that the gas mixture which is produced in the oxidation zone is partially supplied to the reforming zone, bypassing the injection and mixture forming zone.

The invention is based on the conclusion that by separating the oxidation zone and the reforming zone and by mixing the exhaust gas from the oxidation zone with the additionally supplied fuel, a gas mixture may be produced which provides good preconditions with regards to the following reforming and/or which can be optimized by the further supply of exhaust gas and oxidant with regards to the reforming process.

The invention is now explained by way of example referring to the accompanying drawings and the preferred embodiments.

The drawings show in:

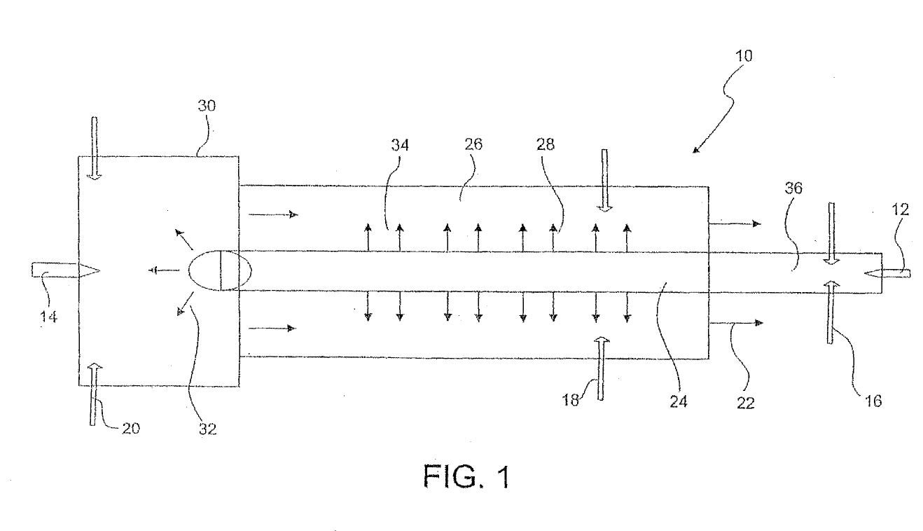

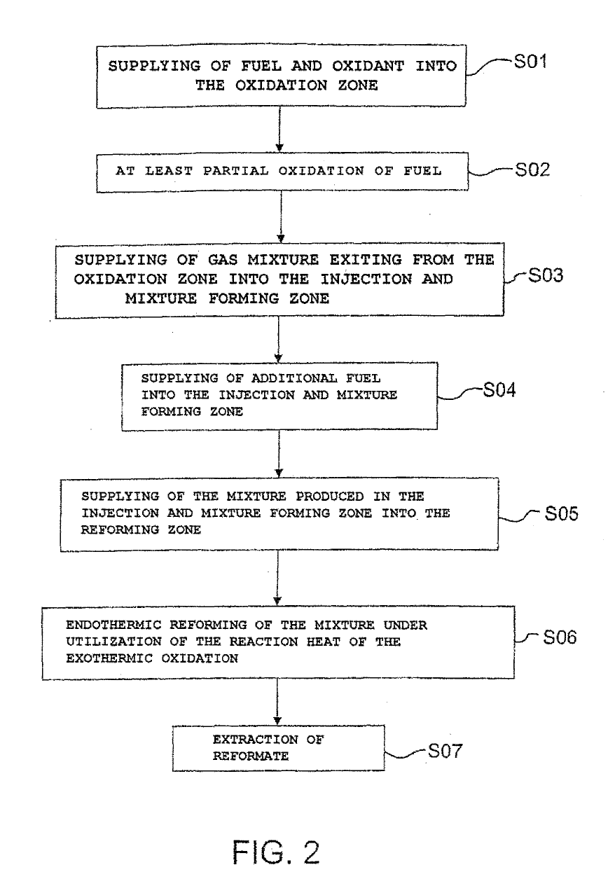

FIG. 1 a schematic diagram of a reformer according to the present invention; and in
FIG. 2 a flow chart for explaining a method according to the present invention.

FIG. 1 shows a schematic diagram of a reformer according to the present invention. Fuel 12 and oxidant 16 can be supplied to the reformer 10 through respective supplies. For the fuel 12, for example diesel may be considered, the oxidant 16 is usually air. The reaction heat generated instantaneous within the initial combustion may be partially discharged in an optionally provided cooling zone 36. The mixture then further proceeds into the oxidation zone 24 which can be realized as a pipe which is arranged within the reforming zone 26. In alternative embodiments, the oxidation zone is realized by multiple pipes or a specific pipe arrangement within the reforming zone 26. Within the oxidation zone, a conversion of fuel and oxidant within an exothermic reaction having λ≈1 takes place. The gas mixture 32 produced thereby then enters an injection and mixture forming zone 30 in which it is mixed with injected fuel 14. The thermal energy of the gas mixture 32 can thereby support the evaporation of the fuel 14. Additionally, it can be provided that oxidant is supplied into the injection and mixture forming zone 30. The thus formed mixture then enters the reforming zone 26 where it is converted in an endothermic reaction, with for example λ≈0.4. The heat 28 needed for the endothermic reaction is discharged from the oxidation zone 24. For optimizing the reforming process, oxidant 18 may be additionally supplied into the reforming zone 26. Further, it is possible to directly supply part of the gas mixture 34 which is produced in the oxidation zone 24 to the reforming zone 26, bypassing the injection and mixture forming zone 30. The reformate 22 then flows out of the reforming zone 26 and is available for further utilization.

FIG. 2 shows a flow chart for explaining a method according to the present invention. In step S01, fuel and oxidant is supplied to an oxidation zone. Thereafter, in step S02, an at least partial oxidation of the fuel occurs. According to step S03, the gas mixture exiting the oxidation zone is supplied to the injection and gas forming zone. Further, in step S04 additional fuel is supplied to the injection and gas forming zone. The mixture produced in the injection and mixture forming zone is then supplied in step S05 to the reforming zone, where it is reformed in step S06 within an endothermic reaction, utilizing the reaction heat of the exothermic oxidation. In step S07 the reformate is extracted.

The features of the present invention disclosed in the preceding description, in the drawings and in the claims can be essential for the implementation of the invention, individually and in combination.

Reference numerals:
12 fuel
14 fuel
16 oxidant
18 oxidant
20 oxidant
22 reformate
24 oxidation zone
26 reforming zone
28 heat
30 injection and mixture forming zone
34 gas mixture
36 cooling zone

1-12. (canceled)

13. A reformer for converting fuel and oxidant into reformate, comprising:
an oxidation zone connected to a supply of fuel and a supply of oxidant and in which the fuel and oxidant are formed into an oxidized mixture;
a reforming zone, and
an injection and mixture forming zone between the oxidation zone and the reforming zone to which at least a portion of the oxidized mixture from the oxidation zone is mixed with an injected supply of additional fuel and from which the mixture with the additional fuel is supplied to the reforming zone upon an at least partial oxidation of the fuel;
wherein the reforming zone is connected to a source of heat.

14. The reformer according to claim 13, wherein the source of heat is an exothermic oxidation produced within the oxidation zone.

15. The reformer according to claim 13, wherein the reforming zone is connected to an oxidant supply which supplies additional oxidant to the reforming zone.

16. The reformer according to claim 13, wherein the oxidation zone comprises at least one pipe which is arranged within the reforming zone.

17. The reformer according to claim 13, wherein the oxidation zone is constructed and arranged to enable a portion of the gas mixture to be supplied to the reforming zone in a manner bypassing the injection and mixture forming zone.

18. A method for converting fuel and oxidant into reformate in a reformer having an oxidation zone and a reforming zone, comprising the steps of:
supplying fuel and oxidant to the oxidation zone and forming a mixture thereof therein,
upon at least partial oxidation of the fuel, delivering at least a portion of the mixture to an injection and mixing zone in which the mixture is mixed with an injected supply of additional fuel,
supplying the mixture with the additional fuel to the reforming zone, and
supplying heat to the reforming zone and at least partially converting the mixture into reformate.

19. The method according to claim 18, wherein the step of supplying heat to the reforming zone is performed with heat from exothermic oxidation of the fuel and oxidant mixture within the oxidation zone.

20. The method according to claim 18, further comprising the step of supplying additional oxidant to the reforming zone.

21. The method according to claim 18, wherein the additional fuel is at least partially evaporated by thermal energy of the gas mixture delivered to the injection and mixing zone from the oxidation zone.

22. The method according to claim 18, wherein a portion of the mixture produced in the oxidation zone is supplied to the reforming zone in a manner bypassing the injection and mixture forming zone.
